(19) United States
(12) Patent Application Publication
(10) Pub. No.: US 2010/0067405 A1
(43) Pub. Date: Mar. 18, 2010

(54) CORE NETWORK DEVICE, RADIO COMMUNICATION BASE STATION DEVICE, AND RADIO COMMUNICATION METHOD

(75) Inventors: Takeshi Kanazawa, Kanagawa (JP); Akito Fukui, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/447,832

(22) PCT Filed: Feb. 8, 2008
(86) PCT No.: PCT/JP2008/000183

§ 371 Date: Apr. 29, 2009

(30) Foreign Application Priority Data
Feb. 9, 2007 (JP) 2007-030957

(51) Int. Cl. H04H 20/71; H04L 12/28

(52) U.S. Cl. 370/254; 370/312

(57) ABSTRACT

Disclosed are a core network device, a radio communication base station device, and a radio communication method which continuously provides a multicast service to a terminal connected to eNB in an overlap PA. An M-UPE (160) which distributes MBMS data to the overlap PA stores an identifier of other M-UPE (170) connected to the overlap PA. When no participating user under the M-UPE (160) is detected upon update of the number of UPE users, the M-UPE (160) continues the multicast service to the M-UPE (170) according to the stored identifier.

### TECHNICAL FIELD

The present invention relates to a core network apparatus, radio communication base station apparatus and radio communication method for providing a multimedia broadcast/multicast service (MBMS).

### BACKGROUND ART

Mobile terminals in a mobile communication system generally need to be registered with a network before being allowed to transmit/receive a desired service. This registration normally includes authentication and approval of mobile terminals in the network and may be referred to as “network attachment.”

The network entity that processes this network attachment generates context state information and a signaling message for each mobile terminal. Therefore, each mobile terminal has load upon this entity.

Since the load that can be processed by a specific network entity has an upper limit, the number of mobile terminals that can be handled by such an entity also has an upper limit. Therefore, the load produced by the mobile terminals needs to be distributed to several network entities.

The mobile communication system can generally be divided into logically classified parts that provide dedicated functions. These are referred to as a “core network (CN)” and an “access network (AN).” Especially, the latter is referred to as a “radio access network (RAN)” in a mobile communication system.

A network entity is normally located on the CN of a mobile communication system. An entity within a RAN and CN uses an interface defined so as to communicate with each other. In order to distribute the load produced by a mobile terminal to several CN entities, the RAN entity that processes a radio connection with the mobile terminal needs to be provided with an interface for the plurality of CN entities. Since the mobile communication system is provided with a plurality of RAN entities, multi-to-multi interfaces are required between the CN entities and RAN entities.

When, for example, development of a mobile communication system in a large area such as one entire country is taken into consideration, it is difficult to set multi-to-multi interfaces between all. RAN entities and all CN entities. For example, for reasons related to security or other network operations, connections of a transport network may be geographically restricted. For this reason, there are cases where only some of all RAN entities may be provided with interfaces for some of all the CN entities. All the entities provided with an interface with each other can be regarded as a logical range within the entire mobile communication network. This is typically referred to as a “pool area (PA).” In consideration of the development of a network, such a PA is made up of a plurality of RAN entities geographically associated with one or a plurality of CN entities. Furthermore, interfaces exist between the entities in the PA.

Furthermore, different PAs may overlap with each other. When a mobile terminal is moving along a boundary between different PAs, the mobile terminal frequently changes its association from one PA to the other PA because of different signal intensities received from the respective RAN entities. Such switching of association requires signaling to update context state information maintained on the network. PA overlapping can bring about a certain degree of hysteresis to avoid frequent updates of context state information.

In consideration of this, there can be such a solution to distribute load produced by a mobile terminal that a RAN node selects arbitrary one of CN entities within the PA at the time of network attachment and transfer a network attachment request to this entity. Assuming a plurality of mobile terminals, two or more terminals connected to the same RAN entity may be assigned to different CN entities. Furthermore, when the RAN entity is located in an overlapping PA, those CN entities are located in different PAs. The UEs each execute network attachment to the assigned CN entities. As a result, according to circumstances, individually requested services maybe provided from different CN entities within different PAs to the mobile terminals through the same RAN entity.

FIG. 1 shows a multicast service architecture in a mobile communication system being standardized by the 3GPP SAE/LTE. A cellular network is traditionally divided into a control plane (C-plane) that processes information and procedures of the entire control system and a user plane (U-plane) that processes actual user data traffic. A multicast C-plane is processed by a C-plane entity of CN assigned to a mobile terminal during network attachment or mobility.

In the SAE/LTE system, the C-plane function of CN is included in a mobility management entity (MME) and all MMEs include a multicast management function as a multicast-MME (M-MME). On the other hand, the U-plane function of CN is included in a user plane entity (UPE). When selected by the M-MME so as to process multicast service data, the UPE provides a U-plane function for a multicast service and becomes a multicast-UPE (M-UPE). Furthermore, depending on the PA size and performance of MME/UPE, at least one M-UPE per PA is selected for the multicast service. From the standpoint of the mobile terminal, the M-MME is the same MME assigned during network attachment or mobility. On the other hand, the M-UPE that provides a multicast service may be different from the UPE assigned to a unicast service.

However, there is no direct association between the mobile terminal and M-UPE for the multicast service. That is, the terminal never maintains any U-plane bearer for the M-UPE. In practice, multicast service data is provided from the M-UPE to the RAN entity that broadcasts data in a cell. Furthermore, IP multicast transport is used for transmission of multicast service data on a network between the M-UPE and RAN entity (eNB).

As described above, two or more mobile terminals connected to the same eNB within the overlapping PA may be assigned to different CN C-plane entities owned by different PAs. UEs connected to the same eNB within the overlapping PA start the same multicast service for different M-MMEs located in different PAs.

Upon receiving this start request from the mobile terminal, the respective M-MMEs register themselves with the M-UPE within the own PA to set multicast U-plane parameters including private IP multicast addresses to deliver multicast service data. Upon receiving a trigger from a BM-SC, the M-MME sends a session start message including the multicast U-plane configuration to all eNBs within the own PA. The session start message includes a multicast service identifier (e.g., TMGI) and a set private IP multicast address.

An eNB within the overlapping PA may receive a plurality of session s tart messages for the same multicast service. This can be identified by using a multicast service identifier (e.g., TMGI). Session start messages received from different PAs include different U-plane configurations (that is, different IP multicast addresses). Therefore, the eNB randomly selects one of the provided multicast U-plane configurations and reports the selection result to the respective M-MMEs that have sent the multicast session start message. This makes it possible to prevent U-planes from overlapping with each other for the same multicast service and establish a multicast U-plane on only one of PAs.
Non-Patent Document 1: 3GPP TS 23.246 v6.10.0 “3rd Generation Partnership Project; Technical Specification Group Services and System Aspects, Multimedia Broadcast/Multicast Services (MBMS), Architecture and functional description”
Non-Patent Document 2: 3GPP TS 25.346 v6.8.0 “3rd Generation Partnership Project; Technical Specification Group Radio Access Network, Introduction of the Multimedia Broadcast/Multicast Services (MBMS) in the Radio Access Network (RAN), Stage 2”
Non-Patent Document 3: 3GPP TS 25.331 v6.10.0 “3rd Generation Partnership Project; Technical Specification Group Radio Access Network, Radio Resource Control (RRC), Protocol Specification”

### DISCLOSURE OF INVENTION

### Problems to be Solved by the Invention

However, since the above described method of establishing a multicast U-plane randomly selects one of the multicast U-plane configurations, the method includes the following problems.

All mobile terminals attached to the PA for which a multicast U-plane has been established may not receive services in the PA due to a service stop request from the mobile terminal, detachment from the network, movement to a different PA or the like. In such a case, context state information of the terminal is removed from the attached M-MME and the registration is removed from the M-UPE upon detecting that the M-MME does not manage the terminal for a specific service.

Furthermore, the M-MME sends a deregistration message to all eNBs in the PA in which a multicast U-plane has been established so far. This also includes eNBs within the overlapping PA. The eNB that has received such a deregistration message from the M-MME stops private IP multicast transmission. However, as described above, since there can be terminals that have started a multicast service in a different PA about the eNBs within the overlapping PA, if the U-plane is finished for the eNBs within the overlapping PA in consideration of the terminals attached to one PA, a multicast service for the remaining terminals attached to the other PA will no longer be provided.

It is an object of the present invention to provide a core network apparatus, radio communication base station apparatus and radio communication method for continuously providing a multicast service to terminals connected to eNBs within an overlapping PA.

### Means for Solving the Problem

The core network apparatus of the present invention adopts a configuration: a user counting section that counts the number of users joining a multimedia broadcast/multicast service (MBMS), in pool area units, per service; a parameter section that stores, when the multimedia broadcast/multicast service in a pool area managed by the core network apparatus, identification information of another core network apparatus that manages another pool area overlapping the pool area managed by the core network apparatus; and a requesting section that, when the number of users counted with respect to a service in the pool area managed by the core network apparatus becomes zero and it is detected that there are no joining users, requests the another core network apparatus to provide the service, using the identification information that is stored.

The radio communication base station apparatus of the present invention adopts a configuration including: an acquisition section that acquires the number of users in pool area units counted by a plurality of core network apparatuses from the plurality of core network apparatuses; a comparing section that compares the number of users acquired from the plurality of core network apparatuses; and a commanding section that commands a core network apparatus that manages a pool area where there are a largest number of users, to provide a multimedia broadcast/multicast service.

### Advantageous Effect of the Invention

The present invention can continuously provide a multicast service for terminals connected to eNBs within an overlapping PA.

### BRIEF DESCRIPTION OF DRAWINGS

FIG. 1 shows a multicast service architecture in a mobile communication system;

FIG. 2 shows a network configuration according to Embodiment 1 of the present invention;

FIG. 3 is a block diagram showing a configuration of the M-MME shown in FIG. 2;

FIG. 4 is a block diagram showing a configuration of the M-UPE shown in FIG. 2;

FIG. 5 is a sequence diagram showing a procedure for joining a multicast group;

FIG. 6 is a sequence diagram showing a session start procedure;

FIG. 7 is a block diagram showing a configuration of the eNB shown in FIG. 2;

FIG. 8 is a sequence diagram showing a procedure for switching between M-UPEs that deliver data during MBMS data delivery according to Embodiment 1 of the present invention;

FIG. 9 is a sequence diagram showing a procedure for switching between M-UPEs that deliver data during MBMS data delivery according to Embodiment 2 of the present invention;

FIG. 10 is a block diagram showing a configuration of an eNB according to Embodiment 2 of the present invention;

FIG. 11 shows a configuration of a network according to Embodiment 3 of the present invention;

FIG. 12 is a block diagram showing a configuration of the M-MME shown in FIG. 11;

FIG. 13 is a block diagram showing a configuration of the BM-SC shown in FIG. 11;

FIG. 14 is a sequence diagram showing a procedure for joining a multicast group according to Embodiment 3 of the present invention; and

FIG. 15 is a sequence diagram showing a procedure for joining a multicast group according to Embodiment 4 of the present invention.

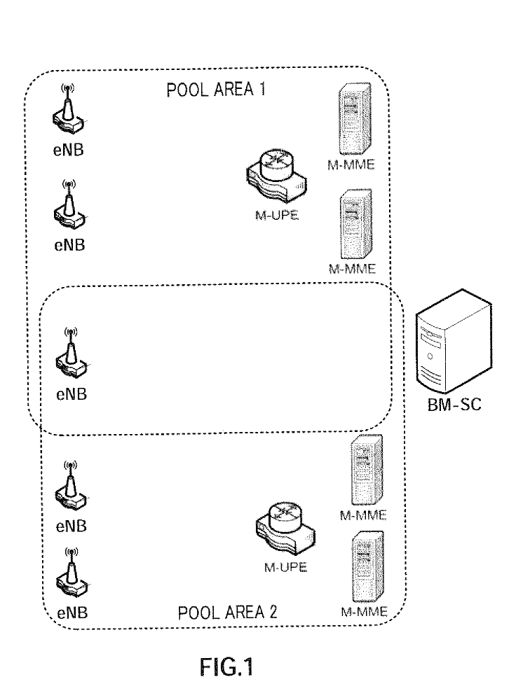

### BEST MODE FOR CARRYING OUT THE INVENTION

Hereinafter, embodiments of the present invention will be explained in detail with reference to the accompanying drawings.

### Embodiment 1

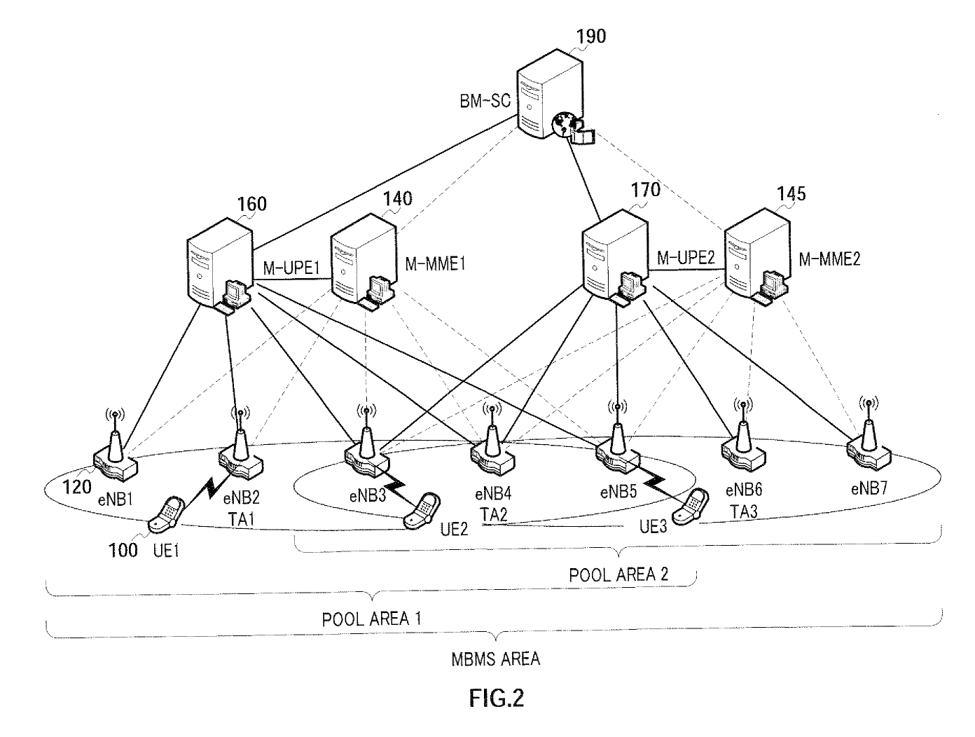

FIG. 2 shows a configuration of a network according to Embodiment 1 of the present invention. The network shown in FIG. 2 is provided with terminal (User Equipment: UE) 100, radio communication base station apparatus (Evolved NodeB: eNB) 120, multicast mobility management apparatus (Multicast Mobility Management Entity: M-MME) 140, multicast user plane apparatus (Multicast User Plane Entity: M-UPE) 160 and broadcast/multicast service center (BM-SC) 190, and eNB 120, M-MME 140 and M-UPE 160 are connected to each other via an IP network.

eNB 120 is in charge of allocation and management of radio resources, receives information transferred from the physical layer of UE 100 via the uplink, and meanwhile, transfers data to UE 100 via the downlink. eNB 120 plays a role of an access point of the radio access network for UE 100.

M-MME 140 manages locations of UE 100 in units of tracking area (TA) and also performs signaling on a setting, correction and release of radio access bearers with UE 100. M-MME 140 stores a context assigned in a network connection procedure of UE 100 and associated with MBMS of UE 100. A plurality of M-MMEs 140 exist in a certain MBMS area and the M-MME to connect differs from one user to another.

M-UPE 160 plays a role as gateway with respect to an outside network and transfers a downlink packet to an eNB to which UE 100 is connected according to the MBMS context. Only one M-UPE 160 exists within a certain MBMS area for each MBMS and stores contexts associated with each MBMS.

BM-SC 190 is located between an MBMS content server and M-UPE 160 and transfers information on the session type, start/end of a service and MBMS data to M-UPE 160.

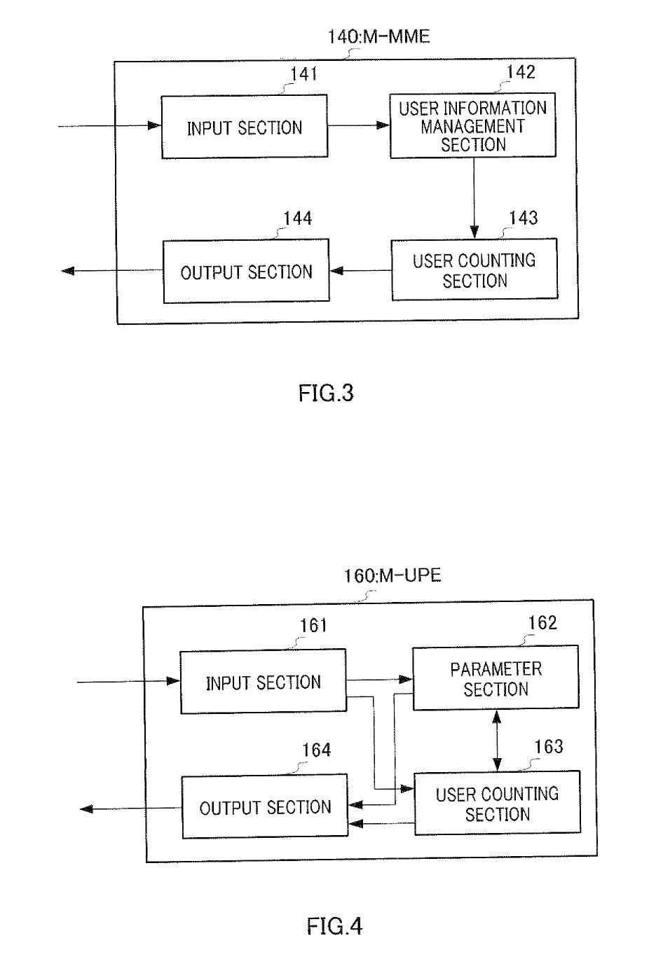

FIG. 3 is a block diagram showing a configuration of M-MME 140 shown in FIG. 2. Input section 141 in FIG. 3 reports signals inputted from BM-SC 190, M-UPE 160 and eNB 120 to user information management section 142.

User information management section 142 compares the MBMS reception performance of UE 100 with the performance of UE 100 included in the MBMS registration response reported from BM-SC 190 and required for the corresponding service. When this comparison result shows that the MBMS reception performance of UE 100 exceeds the performance of UE 100 required for the service, the service and an identifier on a TA to which UE 100 corresponds are reported to user counting section 143. When the MBMS reception performance of UE 100 falls below the performance of UE 100 required for the service, suspension of the processing is reported to BM-SC 190 and UE 100.

User counting section 143 counts the number of users joining each service in TA units and updates the number of users according to the service and the TA identifier reported from user information management section 142. The updated number of users is outputted to output section 144. In this way, M-MME 140 can count the number of users using tracking records of UEs as substitutes.

Output section 144 includes the number of users outputted from user counting section 143 in an MBMS registration update and sends out the MBMS registration update to M-UPE 160.

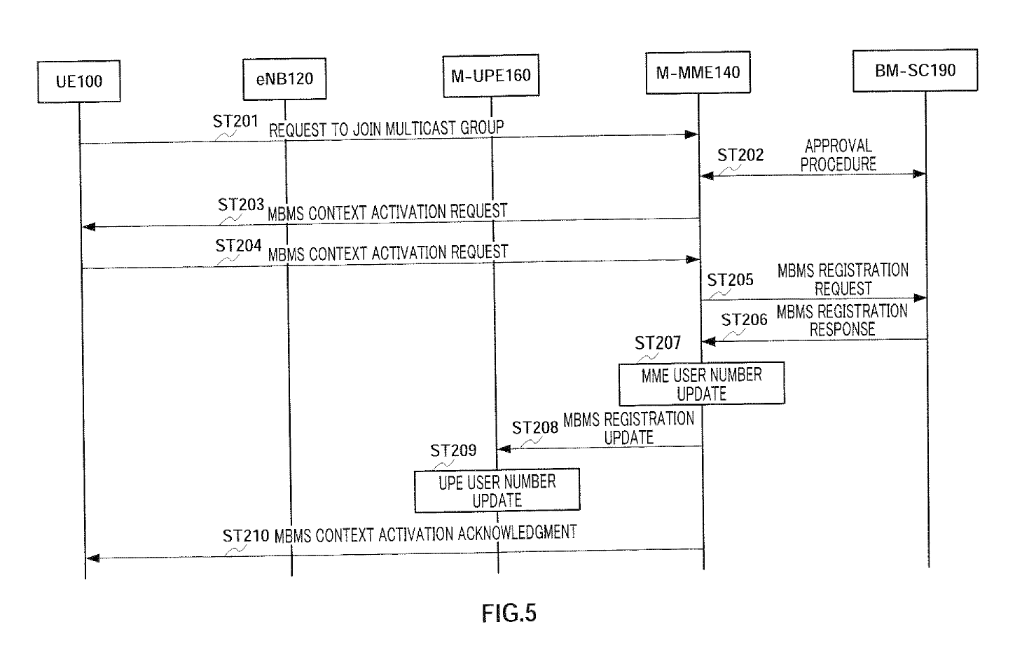

FIG. 4 is a block diagram showing a configuration of M-UPE 160 shown in FIG. 2. In FIG. 4, input section 161 reports the signals inputted from BM-SC 190, M-MME 140 and eNB 120 to parameter section 162 and user counting section 163. Especially, input section 161 reports the number of MBMS users in TA units for each service included in the MBMS registration update to user counting section 163.

Parameter section 162 manages various parameters related to data paths and output s the service data inputted from BM-SC 190 from output section 164 according to the parameter setting.

User counting section 163 counts the number of users joining each service in TA units Since a plurality of M-MMEs 140 exist in the MBMS area, the number of users managed by M-UPE 160 is the sum of the numbers of users reported from the respective M-MMEs. Therefore, M-UPE 160 can know the number of users joining the service that exist within the MBMS area in TA units. Furthermore, since one M-UPE 160 per PA exists for each service, it is possible to figure out the total number of users joining a certain service in the PA by summing up the number of users in all TAs included in the PA. User counting section 163, which has received the MBMS registration update, updates the number of users joining the service and outputs the updated number of users to output section 164.

Output section 164 outputs the service data outputted from parameter section 162 and the number of users outputted from user counting section 163 to eNB 120.

Next, a procedure for a user to join a multicast group will be explained. FIG. 5 is a sequence diagram showing a procedure for joining a multicast group.

In step (hereinafter abbreviated as “ST”) 201, UE 100, which has received a service announcement, sends out a multicast group subscription request to M-MME 140. This multicast subscription request includes an identifier indicating a multicast group UE 100 wants to join.

In ST202, M-MME 140, which has received the multicast subscription request, performs a procedure for approving the user with BM-SC 190. This approval procedure is conducted based on the user's subscriber contract information and decides whether or not the user can receive a service correctly.

When the approval procedure is completed successfully, M-MME 140 sends out a request for MBMS context activation to UE 100 in ST203.

In ST204, UE 100, which has received the MBMS context activation request, sends out an MBMS context activation request to M-MME 140. The MBMS context activation request includes the performance or the like of UE 100 itself to receive MBMS.

When UE 100 is the first to join the multicast group of the service, M-MME 140, which has received the MBMS context activation request, sends out an MBMS registration request to BM-SC 190 in ST205. When UE 100 is not the first to join the multicast group of the service, the processing in ST205 and ST206 will not be performed. The MBMS registration request includes an identifier of M-UPE 160 to deliver MBMS data.

In ST206, BM-SC 190, which has received the MBMS registration request, transmits an MBMS registration response including the performance of UE 100 required for the service to M-MME 140.

In ST207, M-MME 140 counts the number of users joining each service in TA units and updates the number of MME users. In ST208, M-MME 140 sends out the MBMS registration update to M-UPE 160. The MBMS registration update includes the updated number of MBMS users in TA units.

In ST209, M-UPE 160 counts the number of users joining the service located in the MBMS area in PA units and updates the number of UPE users. In ST210, M-MME 140 transmits an MBMS context activation acknowledgment to UE 100.

The processing described so far completes the procedure for the user to join the multicast group. The number of MME users is also updated when the user leaves the multicast group and when the TA of UE 100 is updated likewise. The update result is reported to M-UPE 160 and M-UPE 160 also updates the number of UPE users.

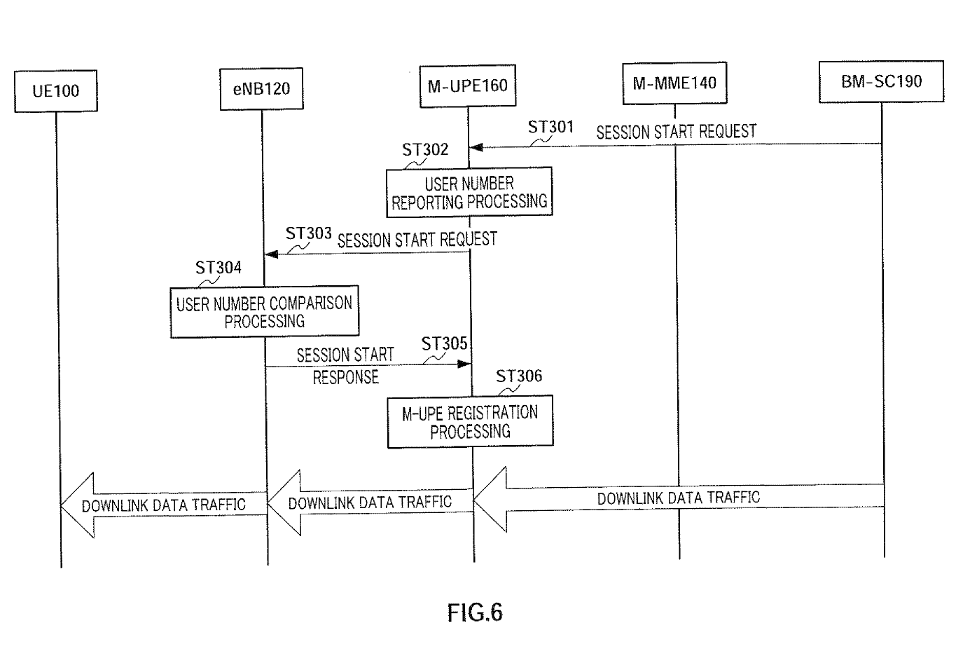

Next, the session start procedure will be explained using FIG. 6. Upon detecting the start of a certain MBMS service, BM-SC 190 sends out a session start request to M-UPE 160 in ST301.

In ST302, user counting section 163 of M-UPE 160, which has received the session start request, reports the number of users joining the service located in the PA to output section 164.

In ST303, the number of users joining the service located in the PA is reported from output section 164 of M-UPE 160 to eNB 120. Since eNBs 120 within the overlapping PA (e.g., eNB3, eNB4 and eNB5 in FIG. 2) are connected to a plurality of M-UPEs (e.g., M-UPE 1 and M-UPE2 in FIG. 2), eNBs 120 receive session start requests for the same service from the different M-UPEs.

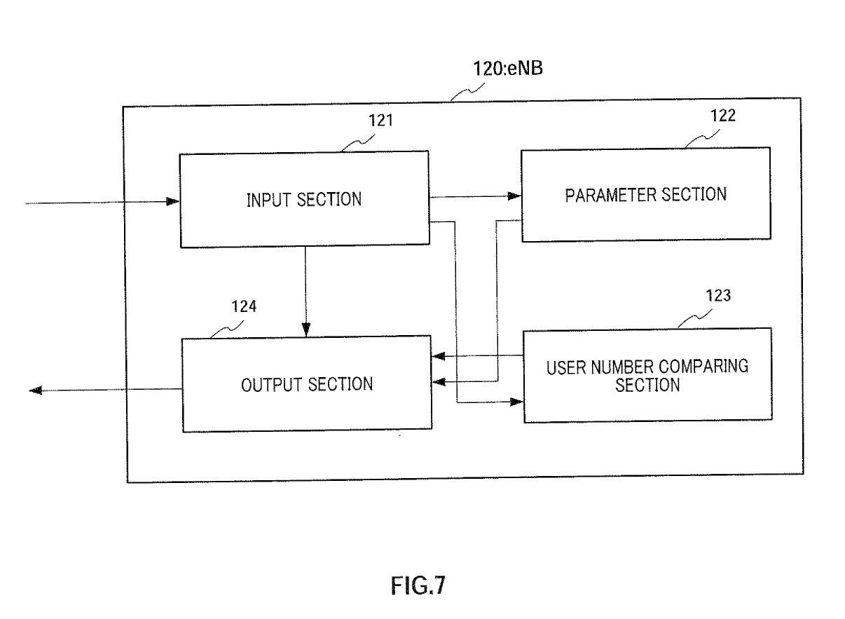

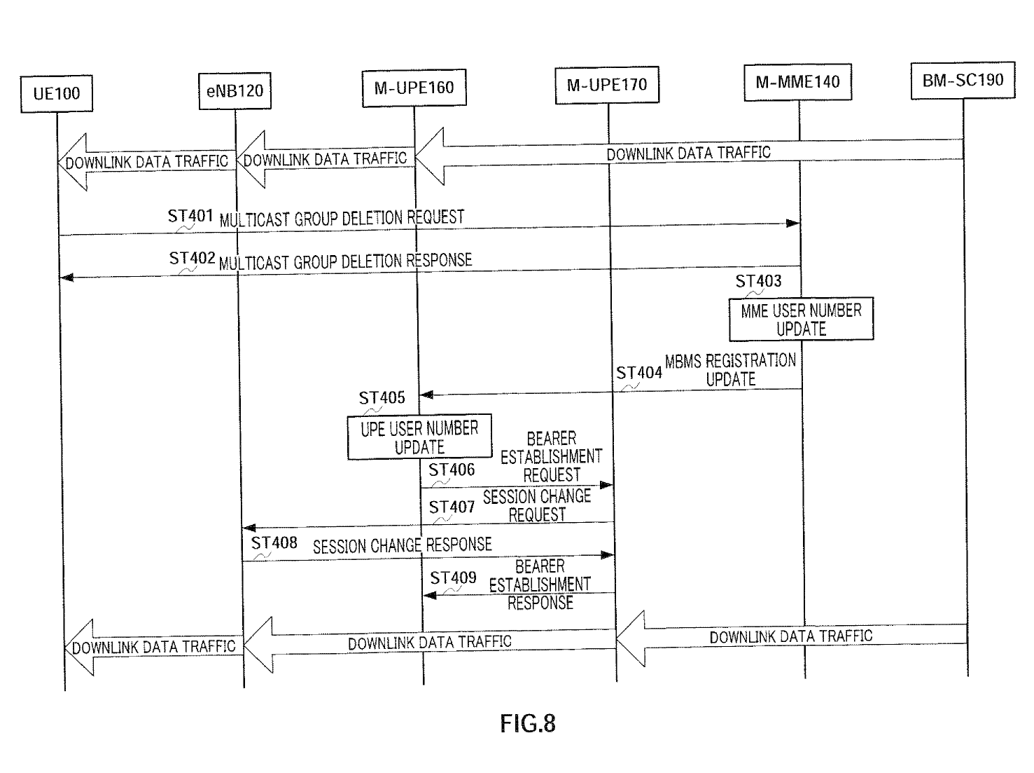

Here, the configuration of above described eNB 120 will be explained. FIG. 7 is a block diagram showing a configuration of eNB 120 shown in FIG. 2. In this figure, input section 121 reports signals inputted from UE 100, M-MME 140 and M-UPE 160 to parameter section 122 and user number comparing section 123. Especially, input section 121 as an acquisition means reports the number of users joining the service included in the session start request received from M-UPE 160 and located in the PA to user number comparing section 123.

Parameter section 122 manages various parameters set through signaling with UE 100, M-MME 140 and M-UPE 160 and MBMS data is outputted from output section 124 according to parameters specified by parameter section 122.

Here, FIG. 6 will be referred to again. In ST304, user number comparing section 123 of eNB 120, which has received the number of users joining the service located in the PA, waits to detect whether or not the number of users joining the service located in another PA is reported to the same multicast service within a predetermined time When the reported number of users is only one, user number comparing section 123 selects M-UPE 160, which has transmitted a session start request, and outputs an identifier of M-UPE 160 to output section 124.

On the other hand, when a plurality of users are reported, user number comparing section 123 selects M-UPE 160 that manages the largest number of users joining the service located in the reported PA and outputs the identifier of selected M-UPE 160 and the identifier of not selected M-UPE 170 to output section 124.

In ST305, output section 124 as an commanding means outputs a session start response including a request for establishing an MBMS bearer for the multicast service and an identifier of not selected M-UPE 170 to selected M-UPE 160 based on the identifier of M-UPE 160 reported from user number comparing section 123.

In ST306, input section 121 of M-UPE 160, which provides the multicast service to the overlapping PA, outputs the identifier of M-UPE 170 reported from eNB 120 and not selected to parameter section 122 and parameter section 122 stores the identifier of M-UPE 160.

This completes a series of session start procedure and MBMS data outputted from BM-SC 190 is sent to M-UPE 160 and is sent to eNB 120 located in the overlapping PA only from one selected M-UPE 160 and finally sent to UE 100 joining a multicast group.

Next, in the case where all mobile terminals attached to the PA in which a multicast U-plane has been established do not receive services in the PA due to, for example, a service stop request from the mobile terminal, detachment from the network or transfer to a different PA, a change of a delivery path of the MBMS data set by the above described session start will be explained.

FIG. 8 is a sequence diagram showing a procedure for switching M-UPEs that deliver data during delivery of MBMS data. In FIG. 8, in ST401, UE 100 reports a multicast group deletion request to M-MME 140 to withdraw from the multicast group.

In ST402, M-MME 140 receives the multicast group deletion request from UE 100 and sends out a multicast group deletion response to UE 100.

In ST403, M-MME 140 updates the number of MME users which is the number of users joining the multicast service in TA units due to the withdrawal of UE 100 from the multicast group. To be more specific, the number of MME users is decremented by one. In ST404, M-MME 140 sends out an MBMS registration update to M-UPE 160. The MBMS registration update includes the updated number of MBMS users in TA units.

In ST405, M-UPE 160 counts the number of users joining the service located in the MBMS area in TA units and updates the number of UPE users. Here, when the updated number of USE users becomes 0, that is, when there is no more user joining the multicast service in the PA, user counting section 163 of M-UPE 160 inquires of parameter section 162 as to whether or not M-UPE 170 of the other PA is stored.

When M-UPE 170 of the other PA is stored in parameter section 162, there may be users attached to the other PA within the overlapping PA. Therefore, in ST406, M-UPE 160 sends out a request for establishing a bearer so as to request M-UPE 170 of the other PA stored in parameter section 162 to deliver the multicast service to eNB 120 within the overlapping PA. The bearer establishment request includes an identifier indicating M-UPE 160 which is the sender. Output section 164 functions as a requesting means.

In ST407, when there are users joining the service in the PA managed by M-UPE 170, M-UPE 170 derives eNB 120 located within the PA overlapping with the PA managed by M-UPE 160 from the identifier of M-UPE 160 included in the reported bearer establishment request. M-UPE 170 sends out a request for changing a session to eNB 120 to request the establishment of an MBMS bearer between eNB 120 and M-UPE 170. The session change request includes the number of users joining the service in PA units as in the case of the session start request.

In ST408, eNB 120 sends out a session change response to M-UPE 170 to form an IP multicast tree on the IP network between eNB 120 and M-UPE 170. Here, when a plurality of session change requests for the same multicast service are received, M-UPE 170, which has sent out a request including the largest number of users is selected as in the case of the processing of the session start request and an identifier of the M-UPE not selected for the session change response is included.

In ST409, M-UPE 170 outputs the information that an MBMS bearer has been established with eNB 120 to M-UPE 160 as a bearer establishment response. M-UPE 160, which has received a bearer establishment response, deletes all parameters of the C-plane and U-plane related to the multicast service.

This completes the procedure for changing the delivery path of a series of MBMS data, MBMS data outputted from BM-SC 190 is sent to M-UPE 170, data is sent to eNB 120 located within the overlapping PA only from M-UPE 170 and finally sent to UE 100 joining the multicast group.

Thus, according to Embodiment 1, M-UPE 160 that delivers MBMS data to the overlapping PA stores an identifier of other M-UPE 170 connected to the overlapping PA, and, when there are no more joining users under the control of M-UPE 160, M-UPE 160 makes other M-UPE 170 continue a multicast service based on the stored identifier, thereby providing the service to users located within the overlapping PA without interrupting the service. Furthermore, Embodiment 1 causes eNB 120 in the overlapping PA to deliver MBMS data starting from the PA having the largest number of joining users in advance, thereby reduce the amount of signaling about the change of the data delivery path between M-UPEs 160 connected to the overlapping PA.

According to the present embodiment, M-UPE 160 counts the number of users joining the service located in the PA but M-UPE 160 may also be adapted so that selected specific M-MME 140 likewise counts the number of users out of the plurality of existing M-MMEs 140.

### Embodiment 2

Embodiment 2 of the present invention will explain a case where when there are no longer users joining a service under the control of M-UPE 160 which has been delivering MBMS data to an overlapping PA, it is decided whether or not there are users connected to another PA within the overlapping PA and M-UPE 170 located in the other PA is requested to change the delivery path of MBMS data.

When there are no longer joining users under the control of M-UPE 160 which has been delivering MBMS data to the overlapping PA, other M-UPE 170 connected to the overlapping PA continues the multicast service. However, since MBMS data may not be delivered to a cell where there are no joining users according to the type of service and requirement for service quality for the effective use of the network and radio resources, signaling on the change of the delivery path of the MBMS data may be wasted when there are no joining users within the overlapping PA. Therefore, when there are no longer joining users under the control of M-UPE 160 which has been delivering MBMS data to the overlapping PA, the present embodiment verifies the presence/absence of joining users within the overlapping PA and then requests a change of the delivery path of HEMS data.

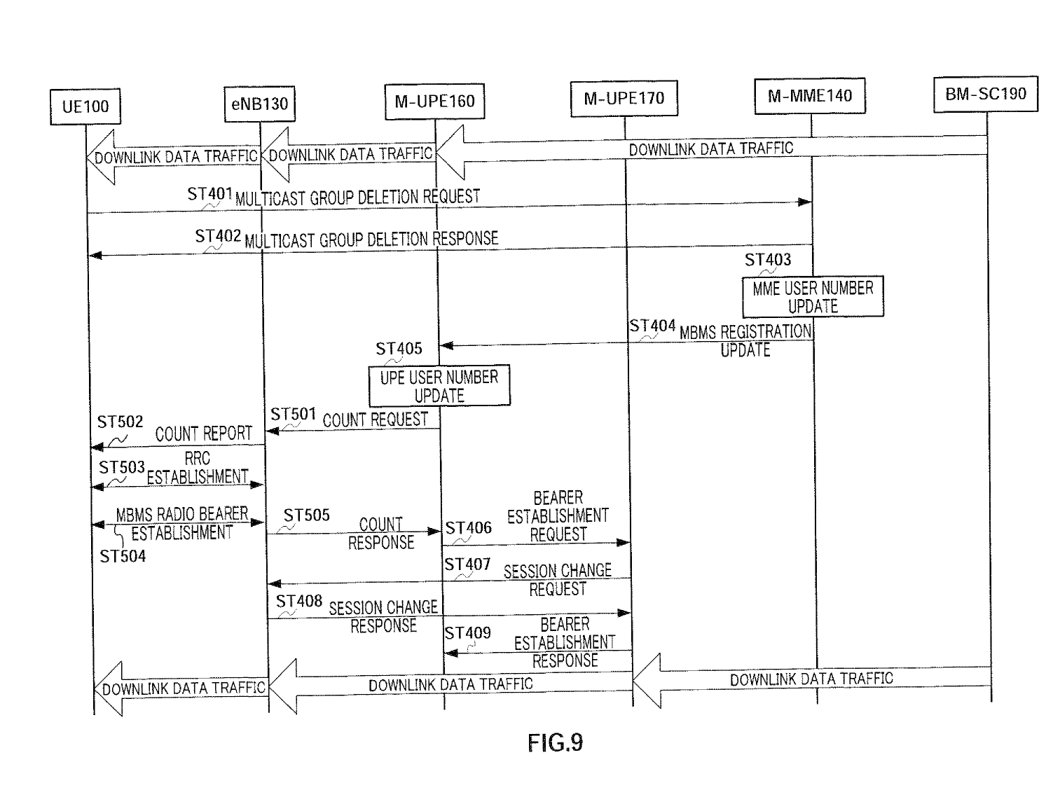

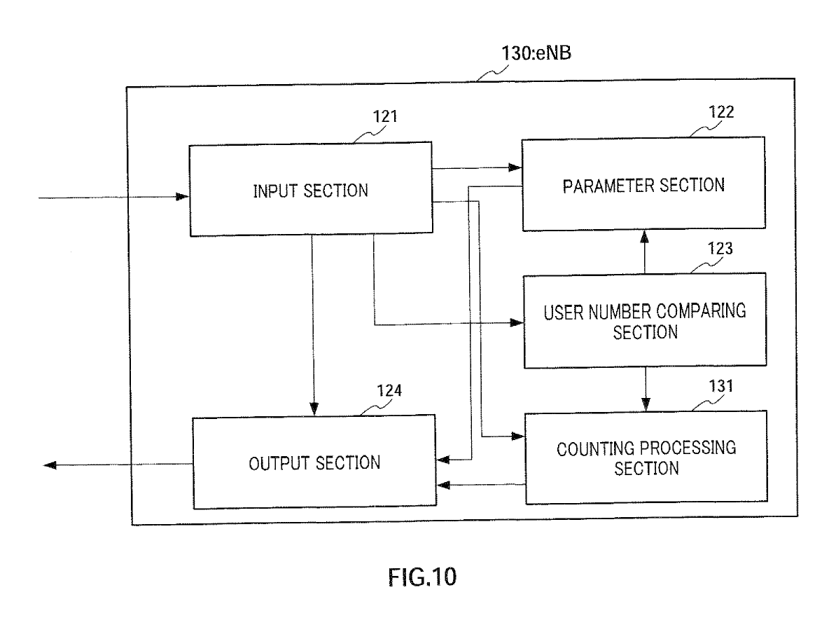

FIG. 9 is a sequence diagram showing a procedure for switching M-UPE 160 that delivers data during delivery of MBMS data according to Embodiment 2 of the present invention. Furthermore, FIG. 10 is a block diagram showing a configuration of eNB 130 according to Embodiment 2 of the present invention. Hereinafter, the procedure for changing the delivery path of MBMS data will be explained using these figures. However, parts in FIG. 9 and FIG. 10, which are common to those in FIG. 7 and FIG. 8 will be assigned the same reference numerals as those in FIG. 7 and FIG. 8 and detailed explanations thereof will be omitted.

M-UPE 160 detects that there are no longer joining users under the control of M-UPE 160, which has been delivering HEMS data to the overlapping PA by detecting that the number of UPE users falls to 0 in ST405. Therefore, M-UPE 160 requests all eNBs 130 within the overlapping PA to perform counting in ST501. Output section 164 functions as a count requesting means.

In ST502, eNB 130 executes counting which is a procedure for verifying the presence of UEs in a cell under the control thereof. The count report includes information indicating on which service counting should be performed and UE 100 thereby decides whether or not to comply with the counting.

Upon receiving information that counting on the service in question is being carried out from the count report, UE 100 sets an RRC connection for eNB 130 in ST503 to report to eNB 130 that UE 100 wants to receive the MBMS service in question. Here, an RRC connection request message is used to report to eNB 130 that UE 100 wants to receive the MBMS. The RRC connection request message includes the identifier of the PA to which UE 100 is attached.

Input section 121 of eNB 130 receives the RRC connection request message from UE 100 and reports the received RRC connection request message to counting processing section 131. Counting processing section 131 recognizes UE 100 which has transmitted the RRC connection request message, thereby recognizes the presence of the user requesting a specific MBMS within the cell and if there is at least one user in the cell, an MBMS radio bearer is set via output section 124 in ST504.

In ST505, counting processing section 131 transmits a count response to M-UPE 160 via output section 124 to show M-UPE 160 that there is a joining user in the cell. The count response includes the identifier of the PA to which UE 100 is attached included in the RRC connection request message. When there is no joining user in all eNBs 130 within the overlapping PA, no PA identifier is included in the count response.

In ST406, M-UPE 160 sends out a bearer establishment request to M-UPE 170 indicated by the PA identifier included in the count response out of M-UPEs 170 in the other PA stored in parameter section 162 to request eNB 130 within the overlapping PA to deliver the multicast service. Since the operation hereinafter is similar to that of Embodiment 1, explanations thereof will be omitted. When no PA identifier is included in the count response, the entire processing on the multicast service is stopped.

In this way, according to Embodiment 2, when there are no longer joining users under the control of M-UPE 160 which has been delivering MBMS data to the overlapping PA, the number of joining users attached to the other PA within the overlapping PA is counted and a change of the delivery path of MBMS data is requested only when there are joining users, and it is thereby possible to reduce the amount of signaling about the change of the delivery path of MBMS data.

### Embodiment 3

Embodiment 3 of the present invention will explain a case where M-UPEs which may deliver MBMS data to an overlapping PA before starting a session register with each other.

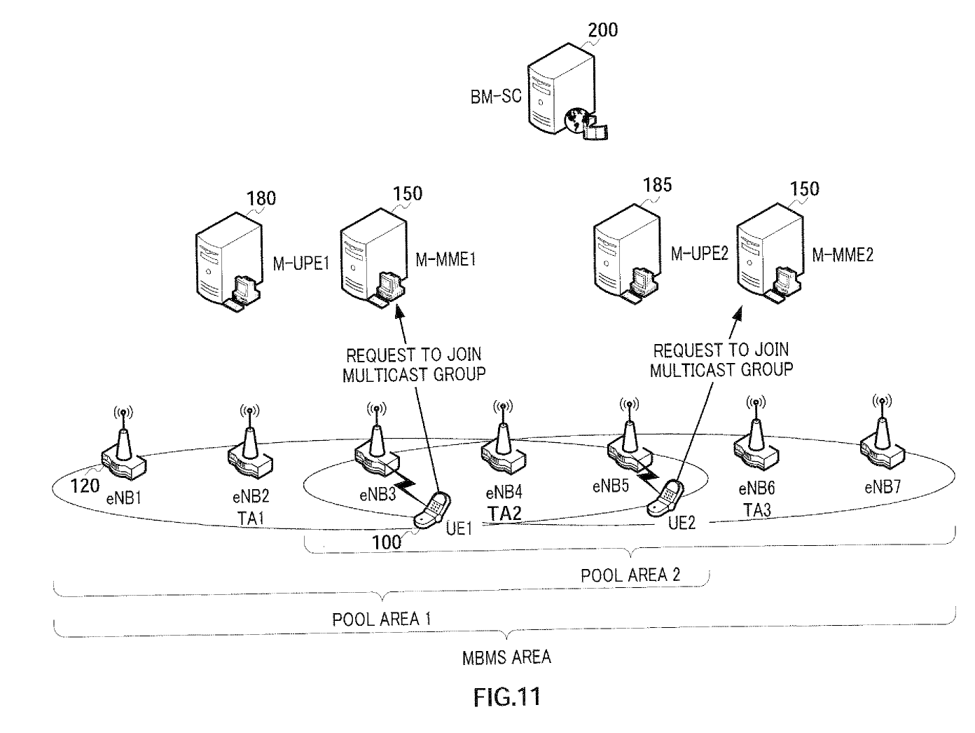

FIG. 11 shows a network configuration according to Embodiment 3 of the present invention. In FIG. 11, suppose there are UEs 100 attached to respective PAs, UE 100 (UE 1) attached to PA1 first joins a certain multicast group and UE 100 (UE2) attached to PA2 then executes a procedure for joining a multicast group corresponding to the same service.

FIG. 12 is a block diagram showing a configuration of M-MME 150 shown in FIG. 11. However, parts in FIG. 12 common to those in FIG. 3 will be assigned the same reference numerals as those in FIG. 3 and detailed explanations thereof will be omitted. In FIG. 12, input section 141 reports an identifier of M-UPE 180 which is included in an MBMS registration response and which has already joined a multicast group to M-UPE selection section 151.

M-UPE selection section 151 selects M-UPE 180 that delivers MBMS data in a PA managed by M-MME 150. Furthermore, M-UPE selection section 151 reports the identifier of selected M-UPE 185 via output section 144 to BM-SC 200 and outputs the identifier to M-UPE 180 which has already joined the multicast group.

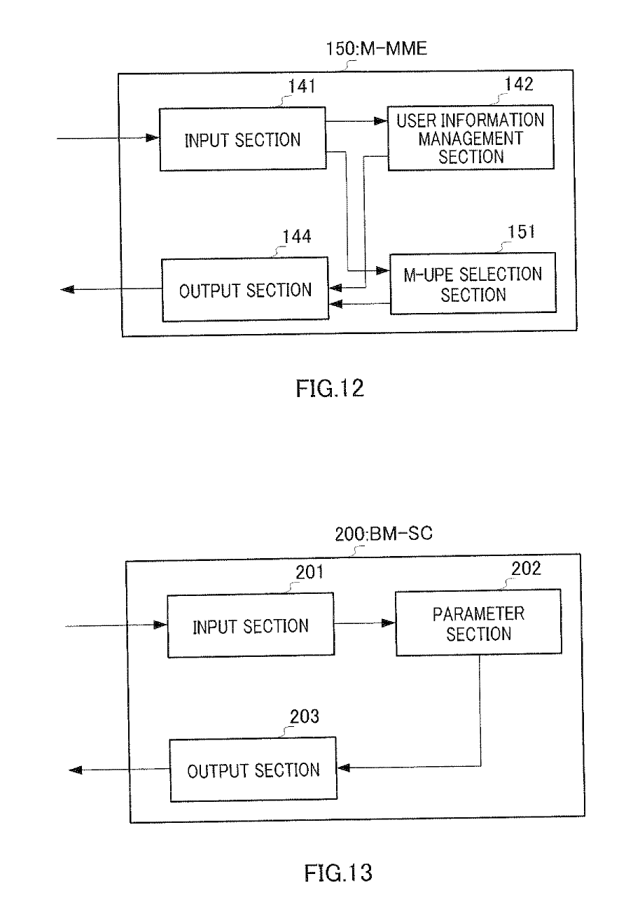

FIG. 13 is a block diagram showing a configuration of BM-SC 200 shown in FIG. 11. In FIG. 13, input section 201 reports the signal inputted from M-MME 150 to parameter section 202. Particularly, input section 201 reports the identifier of selected M-UPE 185 included in the MBMS registration request to parameter section 202.

Parameter section 202 stores the identifier of M-UPE 180 which delivers the MBMS data reported from input section 201 for each service and outputs, when inquired from M-MME 150, the identifier of M-UPE 180 which has already joined the multicast group to M-MME 150 via output section 203.

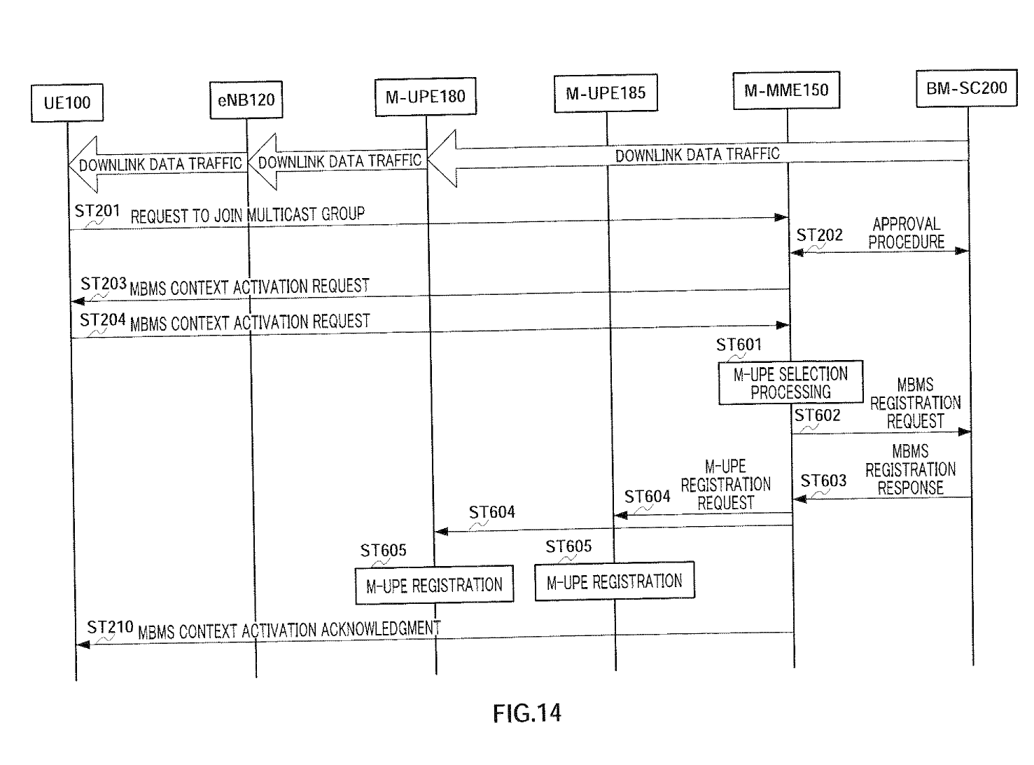

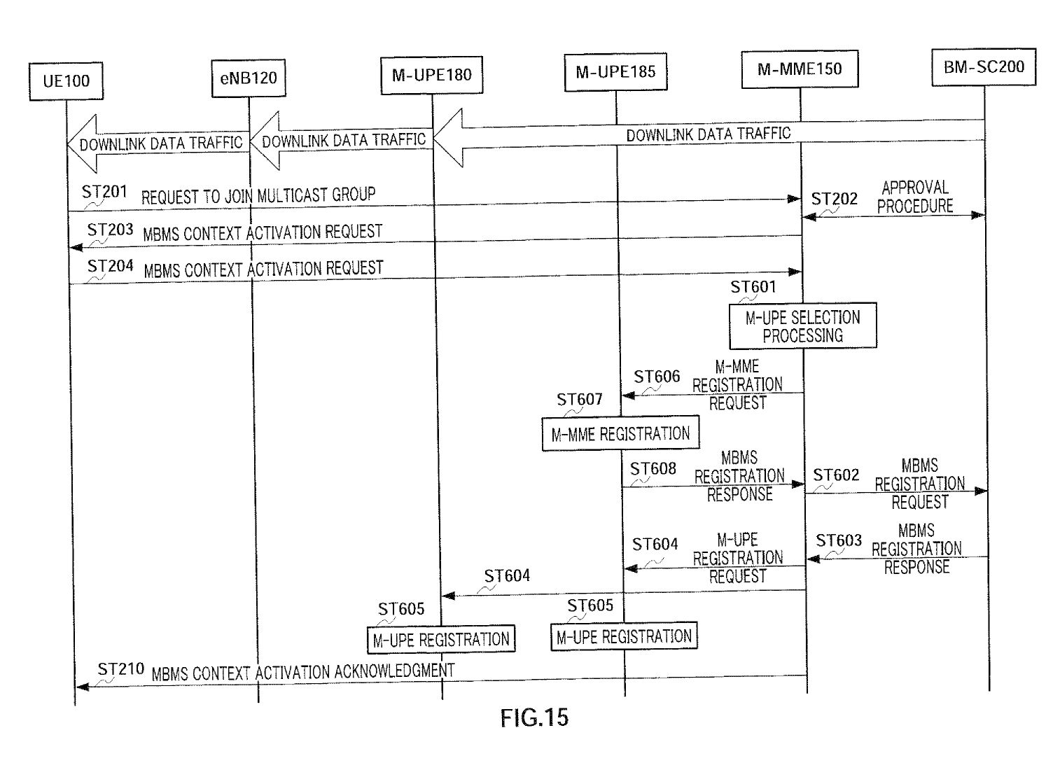

Next, a procedure for joining the multicast group will be explained. FIG. 14 is a sequence diagram showing the procedure for joining the multicast group. However, parts in FIG. 14 common to those in FIG. 5 will be assigned the same reference numerals as those in FIG. 5 and detailed explanations thereof will be omitted.

In ST601, M-MME 150, which has received an MBMS context activation request from UE 100, selects M-UPE 185 that delivers the MBMS data in a PA managed by M-MME 150.

In ST602, M-MME 150 sends out an MBMS registration request to BM-SC 200 in order to register selected M-UPE 185 with BM-SC 200. The MBMS registration request includes the identifier of a service to be delivered and the identifier of selected M-UPE 185.

In ST603, BM-SC 200 registers reported M-UPE 185 with parameter section 202 and also decides whether or not there is any M-UPE 180 which has already joined the multicast group. When there is such M-UPE 180, BM-SC 200 includes the identifier of M-UPE 180 in an MBMS registration response and sends out the MBMS registration response to M-MME 150.

In ST604, M-MME 150 decides from the reported identifier of M-UPE 180 that the PA corresponding to M-UPE 180 overlaps with the PA managed by M-MME 150. M-MME 150 then includes the identifier of M-UPE 185 selected by

M-MME 150 in an M-UPE registration request and reports the M-UPE registration request to M-UPE 180, and includes the reported identifier of M-UPE 180 in the M-UPE registration request and reports the M-UPE registration request to M-UPE 185 selected by M-MME 150.

In ST605, M-UPE 180 and M-UPE 185 store the respectively reported identifiers of M-UPE 180/M-UPE 185 in parameter section 162.

In this way, Embodiment 3 makes M-UPEs which may possibly deliver data to an overlapping PA register with each other beforehand through a procedure for joining a multicast group before starting a session, thereby eliminates the necessity for including identifiers of M-UPEs not selected by all eNBs 120 within the overlapping PA in a session start response, and can thereby reduce the rate of use of network resources.

### Embodiment 4

Embodiment 4 of the present invention will explain a case where from a PA where there is UE 100 which has already joined a multicast group, other UE 100 joins the same multicast group.

Since a plurality of M-MMEs 150 exist in one PA, M-MME 150 to be connected may differ from one UE 100 to another. When a plurality of M-MMEs 150 select M-UPE 185 respectively and register selected M-UPE 185 with BM-SC 200 or M-UPE 180 in another PA, overlapping signaling is performed on the same service. Therefore, according to the present embodiment, M-MME 150 registers itself with selected M-UPE 185.

FIG. 15 is a sequence diagram showing a procedure for joining a multicast group according to Embodiment 4 of the present invention. However, parts in FIG. 15 common to those in FIG. 5 and FIG. 14 will be assigned the same reference numerals as those in FIG. 5 and FIG. 14 and detailed explanations thereof will be omitted.

In FIG. 15, M-MME 150 receives an MBMS context activation request from UE 100, selects M-UPE 185 that delivers the MBMS data in the own PA, then includes a service identifier and the own identifier in an M-MME registration request and outputs the M-MME registration request to selected M-UPE 185 in ST606.

In ST607, M-UPE 185 stores the identifier of M-MME 150 reported from M-MME 150 in parameter section 162 and decides whether or not there is any M-MME 150 already registered in the reported service. When there is registered M-MME 150, as for the reported service, information indicating that registration of M-UPE 185 has already been completed by other M-MME 150 is included in an MBMS registration response and sent out to M-MME 150 in ST608. When the information indicating that registration of M-UPE 185 has already been completed by other M-MME 150 is included in the MBMS registration response, M-MME 150 will not perform subsequent processing.

In this way, according to Embodiment 4, M-MME 150 registers itself with selected M-UPE 185, and can thereby detect that other M-MME 150 has already completed registration of selected M-UPE 185 with BM-SC 200 and M-UPE 180 in the other PA, and can thereby reduce the occurrence of useless signaling for the same service.

The above described embodiments have explained the case where the present invention is configured by hardware as an example, but the present invention can also be implemented by software.

Furthermore, each functional block used for the explanations of the above described embodiments is typically implemented as an LSI which is an integrated circuit. These may be integrated into a single chip individually or may be integrated into a single chip so as to include some or all functional blocks. Here, the term LSI is used, but the term may also be “IC,” “system LSI,” “super LSI” or “ultra LSI” depending on the difference in the degree of integration.

Furthermore, the technique of implementing an integrated circuit is not limited to an LSI but can also be implemented with a dedicated circuit or a general-purpose processor. It is also possible to use an FPGA (Field Programmable Gate Array) which can be programmed or a reconfigurable processor whose connections or settings of circuit cells inside the LSI are reconfigurable after LSI manufacturing.

Moreover, if a technology of realizing an integrated circuit which is substitutable for an LSI appears with the progress in semiconductor technologies and other derived technologies, it is of course possible to integrate functional blocks using the technology. The adaptation of biotechnology or the like can be considered as a possibility.

The disclosure of Japanese Patent Application No. 2007-030957, filed on Feb. 9, 2007, including the specification, drawings and abstract, is incorporated herein by reference in its entirety.

### INDUSTRIAL APPLICABILITY

The core network apparatus, radio communication base station apparatus and radio communication method according to the present invention can continuously provide a multicast service to terminals connected to eNBs within an overlapping PA and are applicable to a transmission control system that provides MBMS.

1. A core network apparatus comprising:
a user counting section that counts the number of users joining a multimedia broadcast/multicast service (MBMS), in pool area units, per service;
a parameter section that stores, when the multimedia broadcast/multicast service in a pool area managed by the core network apparatus, identification information of another core network apparatus that manages another pool area overlapping the pool area managed by the core network apparatus; and
a requesting section that, when the number of users counted with respect to a service in the pool area managed by the core network apparatus becomes zero and it is detected that there are no joining users, requests the another core network apparatus to provide the service, using the identification information that is stored.

2. The core network apparatus according to claim 1, further comprising a count requesting section that, when the number of users counted with respect to a service in a pool area managed by the core network apparatus becomes zero and it is detected that there are no joining users, requests all radio communication ba se station apparatuses in an area where the pool area managed by the core network apparatus overlaps other pool areas to perform counting,
wherein, when the counting result of the radio communication base station apparatus indicates presence of users joining the service, the requesting section requests the another core network apparatus to provide the service.

3. A radio communication base station apparatus comprising:
an acquisition section that acquires the number of users in pool area units counted by a plurality of core network apparatuses from the plurality of core network apparatuses;
a comparing section that compares the number of users acquired from the plurality of core network apparatuses; and
a commanding section that commands a core network apparatus that manage s a pool are a where there are a largest number of users, to provide a multimedia broadcast/multicast service.

4. A radio communication method comprising:
a step of a core network apparatus counting the number of users joining a multimedia broadcast/multicast service (MBMS), in pool area units, per service;
a step of a radio communication base station apparatus acquiring numbers of users in pool area units counted by a plurality of core network apparatuses, from the plurality of core network apparatuses;
a step of comparing the numbers of users acquired from the plurality of core network apparatuses;
a step of commanding a core network apparatus that manages a pool area where there are a largest number of users, to provide a multimedia broadcast/multicast service;
a step of the core network apparatus receiving an instruction to provide the multimedia broadcast/multicast service from the radio communication base station apparatus and storing, when providing the multimedia broadcast/multicast service in a pool area managed by the core network apparatus, identification information of another core network apparatus that manages another pool area that overlaps the pool area managed by the core network apparatus; and
a step of requesting, when the number of users counted with respect to a service in the pool area managed by the core network apparatus becomes zero and it is detected that there are no joining users, the another core network apparatus to provide the service, using the identification information that is stored.
